(19) United States
(12) Patent Application Publication
(10) Pub. No.: US 2019/0280261 A1
(43) Pub. Date: Sep. 12, 2019

(54) APPRATUS FOR ATTACHING AND DETACHING AUXILARY BATTERY OF TRAVEL CARRIER

(71) Applicant: DAESUNG GLOBIZ, INC., Ansan-si (KR)

(72) Inventor: Young Dal CHEON, Gunpo-si (KR)

(21) Appl. No.: 16/293,800

(22) Filed: Mar. 6, 2019

(30) Foreign Application Priority Data
Mar. 6, 2018 (KR) 20-2018-0000967

(51) Int. Cl. H01M 2/10; A45C 15/00; A45C 5/03; H02J 7/00

(52) U.S. Cl. CPC H01M 2/1022; A45C 15/00; H01M 2220/30; H02J 7/0045; A45C 5/03

(57) ABSTRACT

The present disclosure relates to an apparatus for attaching and detaching an auxiliary battery of a travel carrier, which is detachably mounted in the travel carrier regardless of a size and type of the auxiliary battery thereby efficiently responding to airport security screening and realizing user-friendly convenience. The apparatus includes: a body mounted in the travel carrier and having an accommodating part; a battery casing inserted into the accommodating part of the body and detachably housing the auxiliary battery; a controller provided on an upper part of the battery casing, having a first connection port at an upper part and a second connection port at a lower part, and outputting power input through the second connection port to the first connection port; and a connector accommodated in the battery casing and connecting the second connection port and an output port of the auxiliary battery.

### CROSS REFERENCE TO RELATED APPLICATION

The present application claims priority to Korean Utility Model Application No. 20-2018-0000967, filed Mar. 6, 2018, the entire contents of which is incorporated herein for all purposes by this reference.

### BACKGROUND OF THE INVENTION

### Field of the invention

The present disclosure relates generally to a travel carrier provided with an auxiliary battery that is for charging an electronic device such as a mobile phone and, more particularly, to an apparatus for attaching and detaching an auxiliary battery of a travel carrier.

### Description of the Related Art

In the following description, unless otherwise defined, the contents mentioned in this section are not the related art to the claims of the present disclosure, and are not appreciated as the related art even if they are included in this section.

Generally, travelers need a relatively large bag to carry many items required for staying locally during travel or business trip. However, when the large bag contains many necessities, it is difficult, for a user to carry the bag due to relatively large weight and volume.

In order to solve such inconvenience, a travel bag having wheels at its opposite lower sides so that the bag may be pulled, that is, a travel carrier is widely used. Recently, a smart travel carrier equipped with an auxiliary battery for supplying charging power to a potable terminal possessed by the user has been released.

Meanwhile, in many cases, users board an aircraft depending on destinations of their travel or business trip. At this time, when a travel carrier has a size that is possible to carry in a cabin, it is loaded in a storage compartment provided in an upper part of the cabin, but when it has a size that is prohibited in the cabin, it is transported in a state of being loaded in a separate cargo compartment provided in an aircraft.

For the purpose of preventing terrorism, airport security screening is performed for the travel carrier loaded in the aircraft through a variety of devices such as an X-way scanner, etc. At this time, according to airport security screening regulations of each country, the auxiliary battery or the electronic device including it cannot be loaded in the cargo compartment of the aircraft, and are forced to be carried into the cabin after they pass the airport security screening in a portable state.

However, in the case of most of recently released smart travel carriers, as the auxiliary battery is fixedly mounted thereon, charging of the auxiliary battery is inconvenient, and especially, it may be difficult for the auxiliary battery to be detached from the travel carrier at the airport security screening. Since the travel carrier cannot be loaded into the cargo compartment when the auxiliary battery is not detached from the travel carrier, the travel carrier may be inevitably damaged by forcibly detaching the auxiliary battery.

In order to solve the above-mentioned problem, an electronic device mounting equipment for a travel carrier is proposed as disclosed in Korean Utility Model Registration No. 20-0482519 (Feb. 3, 2017). The equipment includes a cap, a lower housing including a locking step that is interlocked by the cap and having a flat surface and a battery housing connected to the locking step and forming a battery housing space, an extended plate provided through a rear side of the locking step, and a rotation supporting part including a rotation plate that is rotationally connected to an upper part of the extended plate and supporting plates respectively provided to face each other on opposite sides of the rotation plate.

In the case of the conventional travel carrier as described above, as an auxiliary battery is detachably coupled to the inside of the battery housing, it is possible to efficiently respond to the airport security screening.

However, in the case of the conventional travel carrier, as the auxiliary battery is directly inserted into the battery housing with a predetermined size, only an auxiliary battery of a particular size and type should be used, and accordingly, a standardized auxiliary battery corresponding to the battery housing should be purchased separately.

The foregoing is intended merely to aid in the understanding of the background of the present disclosure, and is not intended to mean that the present disclosure falls within the purview of the related art that is already known to those skilled in the art.

### DOCUMENTS OF RELATED ART

(Patent Document 1) Korean Utility Model Registration No. 20-0482519 (Feb. 3, 2017).

### SUMMARY OF THE INVENTION

Accordingly, the present disclosure has been made keeping in mind the above problems occurring in the related art, and the present disclosure is intended to propose as apparatus for attaching and detaching an auxiliary battery of a travel carrier, whereby is possible to efficiently respond to the airport security screening and realize user-friendly convenience.

In addition, the present disclosure is not limited to the above-mentioned technical problems, and another technical problem may be derived from the following description.

As one aspect of the present disclosure, the present disclosure may include a body mounted in the travel carrier and having an accommodating part with an open upper surface, a battery casing detachably inserted into the accommodating part of the body and removably housing the auxiliary battery therein, a controller provided on an upper part of the battery casing, the controller having a first connection port at an upper part thereof to be exposed to an upper surface of the battery casing and a second connection port at a lower part thereof, and outputting power input through the second connection port to the first connection port, and a connector accommodated in the battery casing and connecting the second connection port of the controller and an output port of the auxiliary battery accommodated in the battery casing.

According to the exemplary aspect of the present disclosure, the apparatus may include an opening and closing cover rotatably coupled to a rear side of the body, and opening and closing the upper surface of the accommodating part depending on a rotating direction thereof.

According to the exemplary aspect of the present disclosure, the apparatus may include a locking member provided at a front side of the body and maintaining or releasing a closed state of the opening and closing cover.

As described above, the apparatus for attaching and detaching the auxiliary battery of the travel carrier according to the present disclosure is configured such that an auxiliary battery can be detachably mounted to the travel carrier regardless of a size and type of the auxiliary battery, therefore, it can efficiently respond to the airport security screening and can provide the user-friendly convenience without requiring the user to separately purchase a standardized auxiliary battery.

The effects of the present invention are not limited to the above-mentioned effects, and other effects not mentioned can be clearly understood by one of ordinary skill in the art to which this invention belongs from the scope and spirit of the invention.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view showing a travel carrier in which an apparatus for attaching and detaching an auxiliary battery of the travel carrier according to an exemplary embodiment of the present disclosure.

FIG. 2 is a perspective view showing the apparatus for attaching and detaching the auxiliary battery of the travel carrier according to the exemplary embodiment of the present disclosure.

FIG. 3 is an exploded perspective view showing the apparatus for attaching and detaching the auxiliary battery of the travel carrier according to the exemplary embodiment of the present disclosure.

FIG. 4 is an exploded perspective view showing the apparatus for attaching and detaching the auxiliary battery of the travel carrier according to the exemplary embodiment of the present disclosure, the apparatus including a body separately formed of two members.

FIGS. 5 and 6 are perspective views showing examples of using the apparatus for attaching and detaching the auxiliary battery of the travel carrier according to the exemplary embodiment of the present disclosure.

### DETAILED DESCRIPTION OF THE INVENTION

Hereinbelow, features and advantages of the present disclosure and methods of achieving the present disclosure will be more clearly understood from the following detailed description when taken in conjunction with the accompanying drawings. However, the present disclosure may be variously embodied, without being limited to the embodiment described below. The embodiment of the present disclosure described below is provided for allowing those skilled in the art to more clearly comprehend the present disclosure, and the present disclosure is only defined by the scope of the claims. Throughout the drawings, the same reference numerals will refer to the same or like parts.

In the following description, if it is decided that the detailed description of known function or configuration related to the invention makes the subject matter of the invention unclear, the detailed description omitted. Further, technical terms, as will be mentioned hereinafter, are terms defined in consideration of their function in the present invention, which may be varied according to the intention of a user, practice, or the like, so that the terms should be defined based on the contents of this specification.

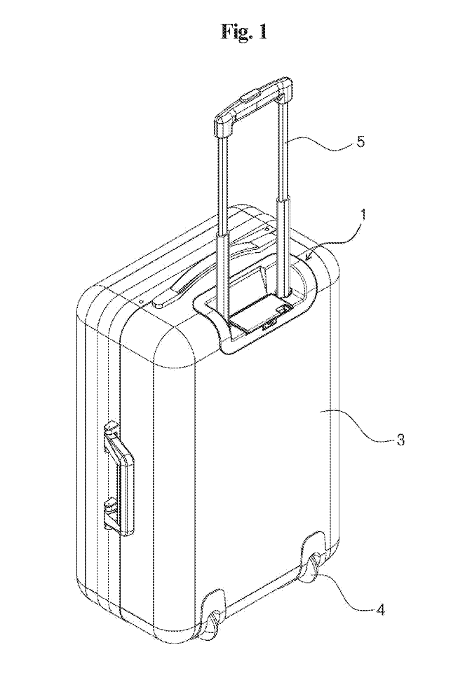

FIG. 1 is a perspective view showing a travel carrier in which an apparatus for attaching and detaching an auxiliary battery of the travel carrier according to an exemplary embodiment of the present disclosure.

Referring to FIG. 1, according to the embodiment of the present disclosure, the travel carrier including the apparatus for attaching and detaching the auxiliary battery of the travel carrier is integrally provided on a side of the travel carrier 3, the travel carrier accommodating items necessary for travel or a business trip, so that the auxiliary battery may be detachably accommodated in the apparatus, and at the same time, power of the auxiliary battery may be utilized as charging power of an user's own electronic device.

The apparatus for attaching and detaching the auxiliary battery of the travel carrier 1 according to an embodiment of the present disclosure is integrally coupled to a front side of the travel carrier including wheels 4 at opposite lower sides thereof, the front side being coupled with handle arms 5.

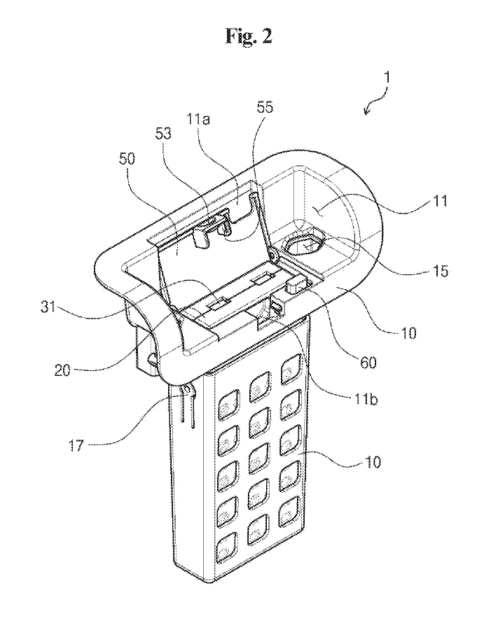

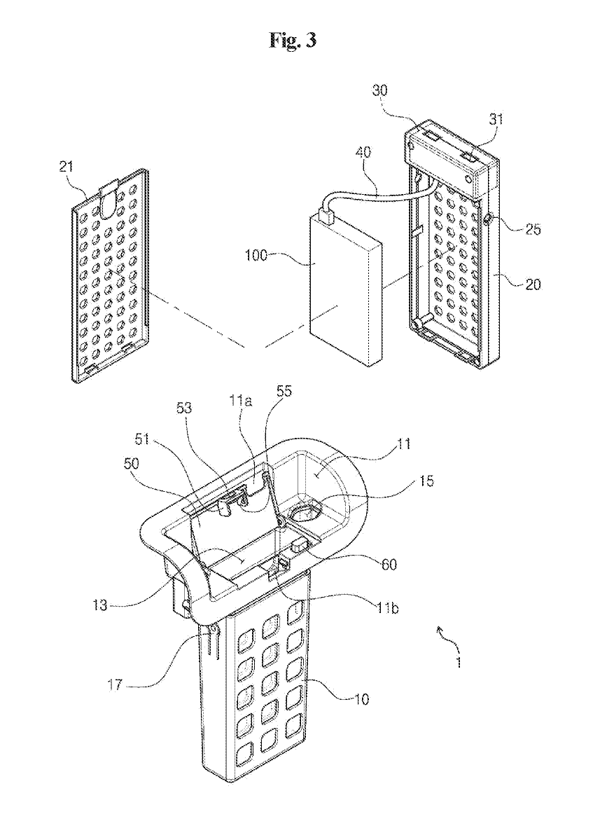

FIG. 2 is a perspective view showing the apparatus for attaching and detaching the auxiliary battery of the travel carrier according to the exemplary embodiment of the present disclosure. FIG. 3 is an exploded perspective view showing the apparatus for attaching and detaching the auxiliary battery of the travel carrier according to the exemplary embodiment of the present disclosure.

Referring to FIGS. 2 and 3, according to the embodiment of the present disclosure, the apparatus for attaching and detaching the auxiliary battery of the travel carrier 1 includes a body 10, a battery casing 20, a controller 30, and a connector 40.

The body 10 forms a frame that is integrally mounted in the travel carrier 3 (referring to FIG. 1), and is configured such that a recess 11 that is open at an upper part and a front part thereof is formed at an upper part of the body seated in and supported by the travel carrier 3 and an accommodating part 13 with an open upper surface is formed at a lower part of the body inside the travel carrier 3 and communicates with a bottom surface of the recess 11.

The recess 11 of the body 10 forms an exposed portion of an upper surface of the battery casing 20, to which a charging cable of the actual user's own electronic device is connected. The bottom surface of the recess 11 forms a plane that is flush with the upper surface of the battery casing 20 that will be described hereinafter.

On a rear surface of the recess 11 of the body 10, a slope support surface 11a is formed. The slope support surface 11a corresponds to a slope surface that supports an opening and closing cover 50 to be described below when the cover is rotated 90° or more in an opening direction.

The accommodating part 13 of the body 10 forms a housing space in which the battery casing 20 with the built-in auxiliary battery 100 is inserted to be removable, and is formed in a housing shape that is open at an upper surface. It is preferable that the housing space of the accommodating part 13 is formed to have a size corresponding to a size of the battery casing 20, so that the upper surface of the battery casing 20 in the accommodating part 13 forms a plane that is flush with the bottom surface of the recess 11.

In addition, on opposite sides of the bottom surface of the recess 11 of the body 10, handle coupling holes 15, through which the handle arms (5; referring to FIG. 1) of the travel carrier 3 pass, are formed to penetrate on the opposite sides thereof.

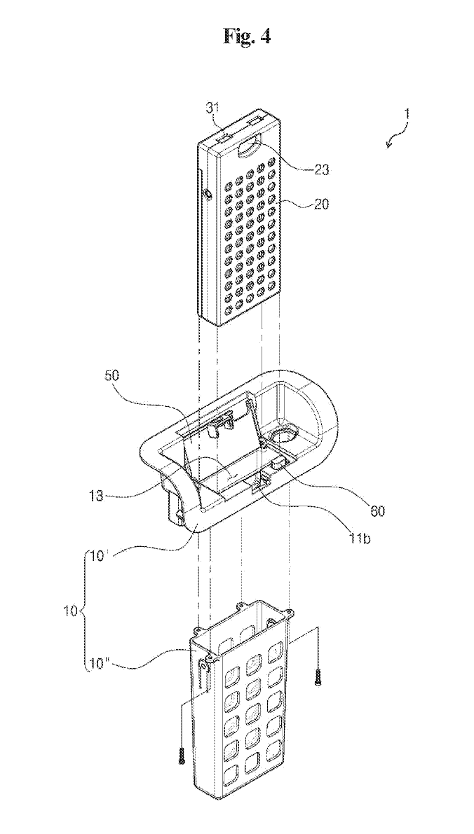

The body 10 described above may be manufactured to be integrally formed by one member, but for manufacturing cost saving and convenience, two members may be separately manufactured and then coupled to each other. FIG. 4 is an exploded perspective view showing the body according to the letter embodiment.

Referring to FIG. A, the body 10 may be manufactured separately as an upper member 10′ seated on and supported by the travel carrier 3 and a lower member 10″ located inside the travel carrier 3.

That is, the body 10 provides the recess 11 that is open at the upper part and the front part thereof, and includes the upper member 10′ providing an upper end part of the accommodating part 13 and the lower member 10″ providing the accommodating part 13 by coupling to the upper member 10′.

The battery casing 20 is inserted into the accommodating part 13 described above. Here, the battery casing 20 is detachably inserted into the accommodating part 13 of the body 10 in a state where the auxiliary battery 100 is accommodated therein to be removable, first. The battery casing 20 functions as a typical storage case for the auxiliary battery 100, which being configured such that the auxiliary battery 100 is inserted in the accommodating part 13 of the body 10 regardless of a size and type thereof.

The battery casing 20 includes a cover 21 for opening and closing a side of the battery casing 20 to accommodate or remove the auxiliary battery 100. The cover 21 is shown to be formed as a slide type cover plate which is attached to or detached from the battery casing 20 by sliding, but the cover is not limited thereto, may be formed as a cover which is coupled to the battery casing 20 by various detachable structures.

In addition, it is preferable that the battery casing 20 is easily removed from the accommodating part 13 in a state of inserting in the accommodating part 13 of the body 10. However, when the accommodating part 13 of the body 10 has a corresponding size to the battery casing 20, the upper surface of the battery casing 20 inserted in the accommodating part 13 does not protrude upward from the bottom surface of the recess 11, and forms the plane that is flush with the bottom surface of the recess 11, therefore it may be difficult to detach the battery casing 20.

An open groove 11b is recessed downward in a front side of the bottom surface of the recess 11, so that the battery casing 20 may be easily removed from the accommodating part 13 even when the upper surface of the battery casing 20 inserted in the accommodating part 13 of the body 10 forms the plane that flush with the bottom surface of the recess 11. A removal groove 23 exposed through the open groove 11b may be recessed in a front-upper part of the battery casing 20.

In this case, when a user inserts a finger into the removal groove 23 exposed through the open groove 11b and applies a predetermined force to lift the battery casing 20 upward, the battery casing 20 may be easily removed from the accommodating part 13 of the body 10.

In addition, as the battery casing 20 is elastically locked when the insertion into the accommodating part 13 of the body 10 is completed, up and down movement or voluntary separation due to impact may be prevented.

Accordingly, the accommodating part 13 of the body 10 has elastic projections 17 at opposite surfaces thereof, the elastic projections 17 being formed by partially cutting the opposite surfaces. In addition, coupling holes 25 may be formed through opposite sides of the battery casing 20, the coupling holes 25 being configured such that the elastic projections 17 on the opposite surfaces of the accommodating part 13 are coupled to the coupling holes 25 so that opposite sides of the battery casing 20 are elastically locked when the battery casing 20 is completely inserted into the accommodating part 13 of the body 10.

In addition, it is preferable that the battery casing 20 has a plurality of heat dissipation holes or is formed of a lattice structure having openings in a predetermined arrangement, so that heat generated from the auxiliary battery 100 may be efficiently dissipated and material cost may be reduced at the same time. Herein, it is preferable that the accommodating part 13 of the body 10 also has the plurality of heat dissipation holes or is formed of the lattice structure having openings in the predetermined arrangement as in the case of the battery casing 20, so that the heat generated from the auxiliary battery 100 may be efficiently dissipated and the material cost may be reduced at the same time.

The controller 30 is provided on an inside-upper part of the battery casing 20 described above. The controller 30 controls input and output of supply power, so that the controller 30 receives power from the auxiliary battery 100 in the battery casing 20 and supplies the power as charging power to the electronic device connected externally, and includes a printed circuit board (PCB) corresponding to the above-described function.

On an upper part of the controller 30, a first connection port 31 for outputting the charging power to the auxiliary battery 100 is provided to be exposed to the upper surface of the battery casing 20. On a lower part of the controller 30, a second connection port (not shown) is provided to receive the power of the auxiliary battery 100 in the battery casing 20. The first connection port 31 of the controller 30 may be provided singly or doubly in accordance with embodiments.

The controller 30 outputs the power of the auxiliary battery 100 input through the second connection port (not shown) through the first connection port 31 as the charging power for the electronic device connected externally.

The connector 40 is accommodated inside the battery casing 20 described above. The connector 40 electrically connects the second connection port (not shown) of the controller 30 and an output port of the auxiliary battery 100 in the battery casing 20, and may be formed as a regular connection cable.

In addition, it is preferable that the accommodating part 13 of the body 10 with the detachably inserted battery casing 20 is opened and closed by the opening and closing cover 50.

The opening and closing cover 50 is coupled to a rear side of the body 10, especially, to a rear side of the bottom surface of the recess 11 of the body 10, so that a first end thereof is rotatable. That is, the opening and closing cover 50 may be formed as a rotatable plate opening and closing the accommodating part 13 of the body 10 depending on a rotational direction.

In addition, on an under part of a second end of the opening and closing cover 50, a projection 51 is formed in a channel-shape structure, which enters in the open groove 11b formed on the front side of the bottom surface of the recess 11 when the opening and closing cover 50 is closed. A hooking groove 53 is formed on the front of the projection 51 for insertion of a user's finger when the opening and closing cover 50 is opened.

On the front of the body 10, especially, on the front side of the bottom surface of the recess 11 of the body 10, a locking member 60 maintains or releases a closed state of the opening and closing cover 50.

The locking member 60 is formed on the front of the bottom surface of the recess 11 of the body 10 to be elastically biased in a closing direction, and the locking member 60 protrudes to be movable in left and right directions through the open groove 11b formed on the front of the bottom surface of the recess 11 of the body 10.

For locking the locking member 60, a locking hole 55 is formed by penetrating on the under surface of the second end of the opening and closing cover 50, especially, on a side surface of the projection 51 to elastically coupled with the locking member 60

In addition to the above-described projection structure, the locking member 60 for maintaining or releasing the closed state of the opening and closing cover 50 may be formed of known various attachment and detachment structures, such as an inter-lockable irregular structure or a magnet, interposed between the opening and closing cover 50 and the locking member 60.

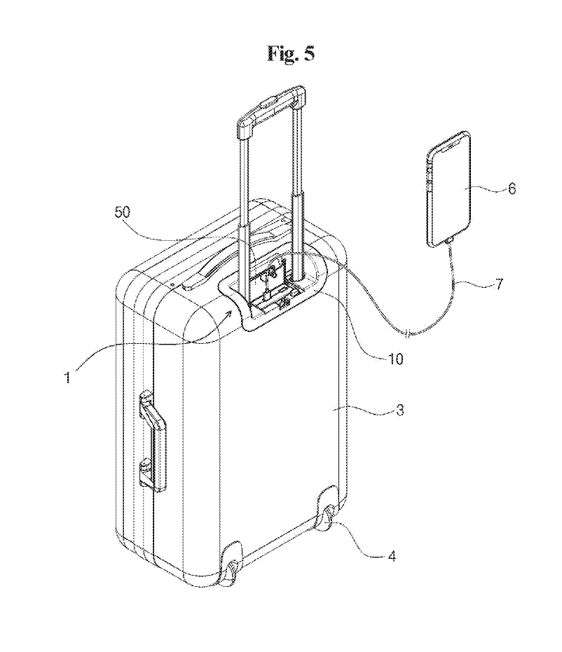

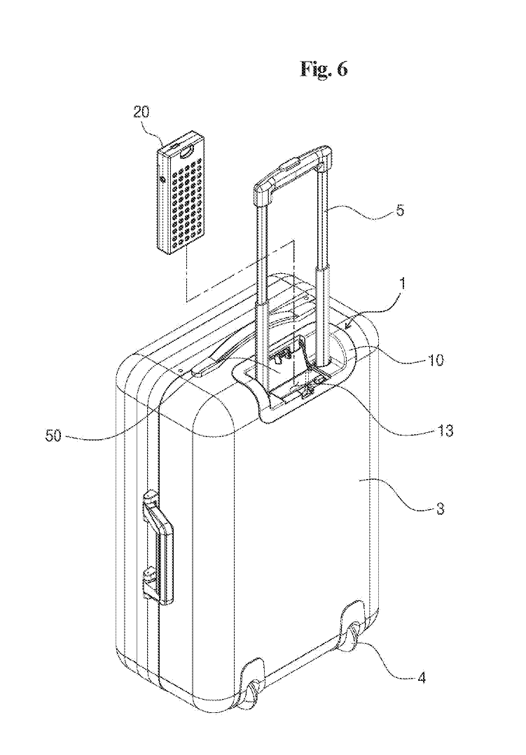

FIGS. 5 and 6 are perspective views showing examples of use of the apparatus for attaching and detaching the auxiliary battery of the travel carrier according to the exemplary embodiment of the present disclosure. Hereinbelow, according to the embodiment of the present disclosure, operation of the apparatus for attaching and detaching the auxiliary battery of the travel carrier 1 will be described in detail with reference to FIGS. 1 to 6.

First, a user opens the cover 21 of the battery casing 20, and puts his or her own auxiliary battery 100 into the battery casing 20. Then, the user electrically connects the second connection port (not shown) of the controller 30 and the output port of the auxiliary battery 100 in the battery casing 20 using the connector 40 and closes the cover 21 again.

In this state, the user inserts the battery casing 20 with the auxiliary battery 100 into the accommodating part 13 in the body 10, then rotates the opening and closing cover 50 in an opened state to close the accommodating part 13 of the body 10 by the locking member 60, and uses the travel carrier 3.

When the electronic device needs to be charged, the user pushes the locking member 60 sideward and rotates the opening and closing cover 50 to the opened state. As shown in FIG. 5, the first connection port 31 exposed to the outside through the upper surface of the battery casing 20 is connected with a charging port of the electronic device 6, such as mobile phone, using the charging cable 7. Then, charging power of the auxiliary battery 100 in the battery casing 20 is supplied to a battery of the electronic device 6 under control of the controller 30 to charge the electronic device 6. When the charging of the electronic device 6 is completed, the user removes the charging cable and rotates the opening and closing cover 50 in the opened state to close.

In addition, when airport security screening requires that the auxiliary battery 100 be completely detached from the travel carrier 3, the user pushes the locking member 60 sideward and rotates the opening and closing cover 50 to the opened state, and as shown in FIG. 6, and inserts a finger into the removal groove 23 exposed through the open groove 11b and applies a predetermined force to lift the battery casing 20 upward. Then, the battery casing 20 removed from the accommodating part 13 of the body 10 may be carried separately. When the auxiliary battery 100 needs to be screened, the auxiliary battery 100 may be removed from the battery casing 20 by opening the cover 21.

Even when charging is required due to discharging of the auxiliary battery 100, the user can removed the auxiliary battery 100 from the battery casing 20 in above-described process and connects the charging cable to an external power source.

When the user uses the apparatus for attaching and detaching the auxiliary battery of the travel carrier 1 according to the present disclosure, as the auxiliary battery 100 is detachably mounted in the travel carrier 3 in a state of being detachably accommodated in the battery casing 20 regardless of its size and type, the user can carry the battery casing 20 with the detachable auxiliary battery 100 by separating to the outside from the travel carrier 3 when necessary such as during airport security screening, for example.

In addition, as the apparatus for attaching and detaching the auxiliary battery of the travel carrier 1 according to the present disclosure applies a double storage structure mediated by the battery casing 20, the user can use his or her own auxiliary battery without having to purchase the auxiliary battery 100 designed for the storage structure of the travel carrier 3, so that user-friendly convenience can be realized.

Although a preferred embodiment of the present disclosure has been described for illustrative purposes, those skilled in the art will appreciate that various modifications, additions and substitutions are possible, without departing from the scope and spirit of the invention as disclosed in the accompanying claims, and the scope of the present invention is not limited to the specific embodiments described above.

What is claimed is:

1. An apparatus for attaching and detaching an auxiliary battery of a travel carrier, the apparatus comprising:
a body mounted in the travel carrier and having an accommodating part with an open upper surface;
a battery casing detachably inserted into the accommodating part of the body and housing the auxiliary battery removably;
a controller provided on an upper part of the battery casing, the controller having a first connection port at an upper part thereof to be exposed to an upper surface of the battery casing and a second connection port at a lower part thereof, and outputting power input through the second connection port to the first connection port; and
a connector accommodated in the battery casing and connecting the second connection port of the controller and an output port of the auxiliary battery accommodated in the battery casing.

2. The apparatus of claim 1, further comprising:
an opening and closing cover rotatably coupled to a rear side of the body, and opening and closing the upper surface of the accommodating part depending on a rotating direction thereof.

3. The apparatus of claim 2, further comprising:
a locking member provided at a front side of the body and maintaining or releasing a closed state of the opening and closing cover.

4. The apparatus of claim 1, wherein a recess that is open at an upper part and a front part thereof is provided at an upper part of the body and the accommodating part is provided at a lower part of the body.

5. The apparatus of claim 4, wherein the body includes an upper member that provides the recess being open at the upper part and the front part and forms an upper end part of the accommodating part, and a lower member that is coupled to the upper member to form the accommodating part.

6. The apparatus of claim 4, wherein, on opposite sides of a bottom surface of the recess of the body, handle coupling holes are formed to penetrate the opposite sides through which handle arms of the carrier are passed.

7. The apparatus of claim 4, wherein an open groove is recessed downward on a front side of a bottom surface of the recess, and a removal groove is recessed on a front-upper part of the battery casing to be exposed through the open groove for easy removal of the battery.

8. The apparatus of claim wherein the accommodating part of the body has elastic projections by partially cutting at opposite side surfaces thereof, and the battery casing has coupling holes at opposite sides thereof to be coupled with the elastic projections when the battery casing is completely inserted into the accommodating part of the body.

9. The apparatus of claim 1, wherein the battery casing includes a cover for housing and removing the auxiliary battery.
